(19) United States
(12) Patent Application Publication
(10) Pub. No.: US 2008/0011189 A1
(43) Pub. Date: Jan. 17, 2008

(54) Inkjet ink set, inkjet ink tank, inkjet recording apparatus, and inkjet recording method

(75) Inventors: Eisuke Hiraoka, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/706,596

(22) Filed: Feb. 15, 2007

(30) Foreign Application Priority Data
Jul. 13, 2006 (JP) 2006-193167

(51) Int. Cl. C09D 11/02; B41J 2/175

(52) U.S. Cl. 106/31.6; 106/31.13; 347/85

(57) ABSTRACT

The invention provides an inkjet ink set for use in an inkjet recording apparatus including a heater that heats a recording medium at least before or after ejecting each liquid of the ink set onto the recording medium, the ink set including: an inkjet ink; and an inkjet processing liquid including at least a compound having a function of aggregating, thickening or insolubilizing a component of the ink, at least one of the ink or the processing liquid including at least one selected from the group consisting of saccharides represented by the following Formula (I) and derivatives thereof: Formula (I): Cₘ(H₂O)ₙ, in Formula (I), m representing an integer of 3 to 6, and n representing an integer of 3 to 6, and at least one of the ink or the processing liquid including a penetrating agent.

### BACKGROUND

1. Technical Field

The present invention relates to an inkjet ink set, inkjet ink tank, inkjet recording apparatus, and inkjet recording method.

2. Related Art

Inkjet systems for ejecting ink from an ink ejection port formed of a nozzle, a slit or a porous film have been used in many printers due to their being small-sized and inexpensive.

Among such inkjet systems, a piezo inkjet system for ejecting ink by utilizing the deformation of a piezoelectric element, and a thermal inkjet system for ejecting ink by boiling an ink with thermal energy and utilizing the boiling characteristics thereof, are superior in high resolution and high-speed printing properties.

Although a variety of recording media for recording with an inkjet recording system, such as plain paper, coated paper, calendered paper, OHP sheets and back print films, are commercially available, low-price plain paper is frequently used for business applications in common offices. In such cases, it is important to decrease and suppress curling generated in recording media. Here, “curling” refers to a phenomenon whereby a paper sheet curls during or after printing.

### SUMMARY

According to an aspect of the invention, there is provided an inkjet ink set for use in an inkjet recording apparatus including a heater that heats a recording medium at least before or after ejecting each liquid of the ink set onto the recording medium, the ink set including:

an inkjet ink; and

an inkjet processing liquid including at least a compound having a function of aggregating, thickening or insolubilizing a component of the ink,

at least one of the ink or the processing liquid including at least one selected from the group consisting of saccharides represented by the following Formula (I) and derivatives thereof:

Cₘ(H₂O)ₙ Formula (I)

in Formula (I), m representing an integer of 3 to 6, and n representing an integer of 3 to 6, and

at least one of the ink or the processing liquid including a penetrating agent.

### BRIEF DESCRIPTION OF THE DRAWINGS

Exemplary embodiments of the present invention will be described in detail based on the following figures, wherein:

FIG. 1 is a perspective view showing an external appearance configuration of an exemplary embodiment of the inkjet recording apparatus of the present invention;

FIG. 2 is a perspective view showing the basic configuration of the inside of the inkjet recording apparatus of FIG. 1;

FIG. 3 is a perspective view showing an external appearance configuration of another exemplary embodiment of the inkjet recording apparatus of the invention; and

FIG. 4 is a perspective view showing the basic configuration of the inside of the inkjet recording apparatus of FIG. 3.

### DETAILED DESCRIPTION

The invention will be set forth hereinafter.

### <Inkjet Ink Set>

The inkjet ink set of the invention (hereinafter, referred to as the ink set in some cases) is used in an inkjet recording apparatus having a heater that heats a recording medium at least before or after ejecting each liquid of the ink set onto the recording medium, and includes an inkjet ink, and an inkjet processing liquid containing at least a compound having a function of aggregating, thickening or insolubilizing a component of the ink, wherein at least one of the ink or the processing liquid contains at least one selected from saccharides represented by the following Formula (I) and derivatives thereof:

Cₘ(H₂O)ₙ Formula (I)

where m represents an integer of 3 to 6, and n represents an integer of 3 to 6, and wherein at least one of the ink or the processing liquid contains a penetrating agent.

The inventors have found that an inkjet ink set of the invention with the above composition may realize high-speed printing and high quality imaging and suppress curling. Its mechanism is not clear; however, it may be estimated as follows.

For the improvement of drying properties of an ink on a recording medium, a method of evaporating water of a recording medium by heating is used. When ejected ink is heated, however, only the surface of the ink is dried and the water of the ink does not penetrate into paper, whereby curling is sometimes increased.

In the case where a recording medium is heated, a balance of the heating and the penetration of an ink and processing liquid into the recording medium needs to be maintained. For the promotion of the penetration of an ink and processing liquid, inclusion of a penetrating agent in at least one of the ink or the processing liquid keeps the balance of the heating and the penetration of the water, thereby enabling the prevention of curling.

Furthermore, when water is applied to a paper recording medium, hydrogen bonds between cellulose fibers of paper are once broken. In other words, the application of water causes swelling of cellulose and also chemical phenomena. At this time, due to the swelling of paper, the paper recording medium curls to the side opposite to the side to which water is applied. However, the water once absorbed in the cellulose gradually evaporates, whereby hydrogen bonds, which were once broken, are recombined. In this case, the recombination does not occur at the same sites but at different sites, so that the paper curls to the side to which water is applied.

As such, the inclusion of at least one selected from the saccharides and derivatives thereof in at least one of an ink or processing liquid makes it possible to cause the saccharides and derivatives thereof to react with the recombination portions of hydrogen bonding, thereby enabling the prevention of curling more effectively.

For this reason, an inkjet ink set of the invention with the above composition may realize high-speed printing and high quality imaging and suppress curling.

Each component will be described hereinafter.

### (Saccharides and Derivatives Thereof)

First, saccharides represented by Formula (I) and derivatives thereof will be set forth:

Cₘ(H₂O)ₙ Formula (I)

wherein m presents an integer of 3 to 6 (particularly 5 to 6), and n represents an integer of 3 to 6 (particularly 5 to 6).

Saccharides of Formula (I) include monosaccharides such as trioses having 3 carbon atoms, tetroses having 4 carbon atoms, pentoses having 5 carbon atoms, and hexoses having 6 carbon atoms. Examples of the trioses include glyceraldehyde and dihydroxyacetone. Examples of the tetroses include D- and L-erythroses and threose. Examples of the pentoses include D- and L-riboses, lyxose, xylose, and arabinose. Examples of the hexoses include D- and L-alloses, altrose, glucose, gulose, idose, fructose, galactose, talose, and mannose.

Specific examples of the derivatives of Formula (I) include sugar alcohols, sugar acids, and sugar amines, and ethers thereof, esters thereof, and the like.

Examples of the sugar alcohols include glycerin, D-sorbitol, D-mannitol, erythritol, D-threitol, xylitol, D-arabinitol, ribitol, allitol, D-altritol, D-glucitol, D-iditol, and galactitol; examples of the sugar acids include tartronic acid, tartaric acid, D-erythronic acid, D-erythruronic acid, erythraric acid, D-threonic acid, D-threuronic acid, D-threaric acid, D-ribonic acid, D-riburonic acid, ribaric acid, D-arabinonic acid, D-arabinuronic acid, D-arabinaric acid, D-xylonic acid, D-xyluronic acid, xylaric acid, D-lyxonic acid, D-lyxuronic acid, D-allonic acid, D-alluronic acid, allaric acid, D-altronic acid, D-altruronic acid, D-altraric acid, D-gluconic acid, D-glucuronic acid, D-glucaric acid, D-mannonic acid, D-mannuronic acid, D-mannaric acid, D-gulonic acid, D-guluronic acid, D-idonic acid, D-iduronic acid, D-idaric acid, D-galactonic acid, D-galacturonic acid, galactaric acid, D-talonic acid and D-taluronic acid; examples of the sugar amines include glucosamine, chondrosamine, mannosamine, galactosamine, fucosamine, quinovosamine, rhamnosamine, and nojirimycin; examples of the ethers include methyl glucoside, ethyl glucoside, and butyl glucoside; examples of the esters include monoglyceride acetate, monoglyceride lactate, and monoglyceride citrate.

The content of the saccharides and derivatives thereof may be in the range of 5 to 40 mass %, particularly in the range of 15 to 35 mass %, more particularly in the range of 20 to 30 mass %, based on the total mass of the ink or the processing liquid.

### (Penetrating Agent)

A penetrating agent improves wetting and penetrating properties of an ink to a recorded medium. In general, the adjustment of the surface tension of an inkjet ink controls penetration properties of the ink into a recording medium. Examples of the penetrating agents include surfactants and penetrating organic solvents. Surfactants may be used alone, or in combination with penetrating organic solvents.

The surfactant may be a nonionic surfactant in terms of dispersion properties of a pigment. Examples of the nonionic surfactants include polyoxyethylenealkyl ethers, polyoxyethylenealkylphenyl ethers, polyoxyethylene fatty acid esters, sorbitan fatty acid esters, polyoxyethylenesorbitan fatty acid esters, polyoxyethylenesorbitol fatty acid esters, glycerin fatty acid esters, polyoxyethyleneglycerin fatty acid esters, polyglycerin fatty acid esters, sucrose fatty acid esters, polyoxyethylenealkylamines, polyoxyethylenealkyl fatty acid amides, alkylalkanolamides, polyethylene glycol polypropylene glycol block copolymers, acetylene glycol, and polyoxyethylene adducts of acetylene glycol; and specific examples include polyoxyethylenenonylphenyl ether, polyoxyethyleneoctylphenyl ether, polyoxyethylenedodecylphenyl ether, polyoxyethylenealkyl ether, polyoxyethylene fatty acid esters, sorbitan fatty acid esters, polyoxyethylene sorbitan fatty acid esters, fatty acid alkylolamides, polyethylene glycol polypropylene glycol block copolymers, acetylene glycol, and polyoxyethylene adducts of acetylene glycol.

These surfactants may be used alone or in a mixture thereof. The HLB of the surfactant (value expressing the degree of affinity of a surfactant to water or oil) maybe in the range of 5 to 20, particularly in the range of 10 to 20, taking into account the dissolution stability and the like.

Some methods are proposed for calculating HLB. For instance, in the Griffin method, HLB is defined as HLB value=20×(total formula weight of hydrophilic portions)/(molecular weight).

A penetrating organic solvent refers to an additive for improving the penetration of an ink into a recorded medium.

Examples of the penetrating organic solvents include triethylene glycol monobutyl ether, 1,2-hexanediol, ethylene glycol monobutyl ether, diethylene glycol monobutyl ether, propylene glycol monobutyl ether, diethylene glycol monohexyl ether, dipropylene glycol monobutyl ether, triethylene glycol monohexyl ether, diethylene glycol monocyclohexyl ether, triethylene glycol monophenylethyl ether, dioxypropyleneoxyethylene monopentyl ether, and the like.

The addition amount of the penetrating agent may be in the range of 1 mass % to 20 mass %, particularly in the range of 1 mass % to 15 mass %, more particularly in the range of 3 mass % to 10 mass %, based on the total mass of the ink or the processing liquid.

### (Ink)

An ink in the invention may contain at least water, a colorant and a water-soluble solvent and, as required, may further contain other additives.

### (Colorant)

Next, the colorant will be explained. As the colorant, either a dye or a pigment may be used. A pigment may be used in terms of a high density image. As a pigment, either an organic pigment or an inorganic pigment may be used. Examples of black pigments include carbon black pigments such as a furnace black, a lamp black, an acetylene black, and a channel black. Examples of pigments other than black pigments and pigments of three primary colors of cyan, magenta and yellow include specific color pigments of red, green, blue, brown, white, or the like, metal glossy pigments of gold, silver, or the like, colorless or pale color extender pigments, plastic pigments, or the like. Moreover, a pigment newly synthesized for the invention may be used as well.

Moreover, particles prepared by fixing a dye or a pigment onto the surface of silica, alumina, polymer beads, or the like as the core, an insoluble lake product of a dye, a colored emulsion, a colored latex, or the like may also be used as a pigment.

Specific examples of the black pigment include RAVEN 7000, RAVEN 5750, RAVEN 5250, RAVEN 5000 ULTRA II, RAVEN 3500, RAVEN 2000, RAVEN 1500, RAVEN 1250, RAVEN 1200, RAVEN 1190 ULTRA II, RAVEN 1170, RAVEN 1255, RAVEN 1080 AND RAVEN 1060 (manufactured by Columbian Carbon Company); REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300 and MONARCH 1400 (manufactured by Cabot Corporation): COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A and SPECIAL BLACK 4 (manufactured by Degussa Co.): and No. 25, No. 33, No. 40, No. 47, No. 52, No. 900, No. 2300, MCF-88, MA 600, MA 7, MA 8 and MA 100 (manufactured by Mitsubishi Chemical Co., Ltd.). However, the pigments are not restricted thereto.

While specific examples of the cyan color pigments include C.I. Pigment Blue-1, -2, -3, -15, -15:1, -15:2, -15:3, -15:4, -16, -22 and -60, the pigments are not restricted thereto.

While specific examples of the magenta color pigments include C.I. Pigment Red-5, -7, -12, -48, -48:1, -57, -112, -122, -123, -146, -168, -177, -184, -202, and C.I. Pigment Violet-19, the pigments are not restricted thereto.

While specific examples of the yellow color pigments include C.I. Pigment Yellow-1, -2, -3, -12, -13, -14, -16, -17, -73, -74, -75, -83, 93, -95, -97, -98, -114, 128, -129, -138, -151, -154 and -180, the pigments are not restricted thereto.

A pigment self-dispersible in water may be used as a colorant. The pigment self-dispersible in water refers to a pigment having many water-solubilizing groups on the surface of the pigment, which can be stably dispersed in water without adding any polymer dispersant. A pigment self-dispersible in water may be obtained by applying surface modification treatments such as an acid or a base treatment, a coupling agent treatment, a polymer graft treatment, a plasma treatment or a redox treatment on usual pigments.

As a pigment self-dispersible in water, in addition to the surface-modified pigments described above, commercially available pigments such as CAB-O-JET-200, CAB-O-JET-300, IJX-157, IJX-253, IJX -266, IJX -273, IJX -444, IJX -55, and CABOT 260 (manufactured by Cabot Corporation), and MICROJET BLACK CW-1 and CW-2 (manufactured by Orient Chemical Industries, Ltd.) may also be used.

As a self dispersing pigment, a pigment having as a functional group at least a sulfonic acid, a sulfonate, a carboxylic acid, or a carboxylate on the surface thereof may be used. A pigment having as a functional group at least a sulfonic acid or a sulfonate on the surface thereof may be used.

A pigment coated with a resin may be used as the colorant. Such pigments are called microcapsule pigments, examples of which include commercially available microcapsule pigments manufactured by Dainippon Ink & Chemicals, Inc. and Toyo Ink MFG Co., Ltd. as well as microcapsule pigments prepared for use in the present invention.

Moreover, a resin dispersing type pigment with a polymer substance chemically bonded with the above-mentioned pigment may also be used.

Examples of the dyes capable of being used in an ink in the invention include direct dyes, acidic dyes, food dyes, basic dyes, reactive dyes, disperse dyes, vat dyes, soluble vat dyes, reactive disperse dyes, fat dyes and the like.

Specific examples include C.I. Direct Black-2, -4, -9, -11, -17, -19, -22, -32, -80, -151, -154, -168, -171, -194, -195;

C.I. Direct Blue-1, -2, -6, -8, -22, -34, -70, -71, -76, -78, -86, -112, -142, -165, -199, -200, -201, -202, -203, -207, -218, -236, -287, -307;

C.I. Direct Red-1, -2, -4, -8, -9, -11, -13, -15, -20, -28, -31, -33, -37, -39, -51, -59, -62, -63, -73, -75, -80, -81, -83, -87, -90, -94, -95, -99, -101, -110, -189, -227;

C.I. Direct Violet-2, -5, -9, -12, -18, -25, -37, -43, -66, -72, -76, -84, -92, -107;

C.I. Direct Yellow-1, -2, -4, -8, -11, -12, -26, -27, -28, -33, -34, -41, -44, -48, -58, -86, -87, -88, -132, -135, -142, -144, -173;

C.I. Food Black-1, -2;

C.I. Acid Black-1, -2, -7, -16, -24, -26, -28, -31, -48, -52, -63, -107, -112, -118, -119, -121, -156, -172, -194, -208;

C.I. Acid Blue-1, -7, -9, -15, -22, -23, -27, -29, -40, -43, -55, -59, -62, -78, -80, -81, -83, -90, -102, -104, -111, -185, -249, -254;

C.I. Acid Red-1, -4, -8, -13, -14, -15, -18, -21, -26, -35, -37, -52, -110, -144, -180, -249, -257; and

C.I. Acid Yellow-1, -3, -4, -7, -11, -12, -13, -14, -18, -19, -23, -25, -34, -38, -41, -42, -44, -53, -55, -61, -71, -76, -78, -79, -122, but are not limited thereto.

The content of the colorant may be in the range of 0.1% by mass to 20% by mass, particularly 1% by mass to 10% by mass, based on the total mass of the ink. Sufficient optical density may not be obtained when the content of the colorant in the liquid is less than 0.1% by mass, while the liquid ejection characteristics may become unstable when the content of the colorant is larger than 20% by mass.

As needed, a colorant may be contained in the processing liquid described hereinafter. The content of the colorant contained in the processing liquid in this case may be 0.1% by mass to 20% by mass, and particularly 1% by mass to 10% by mass. Since the processing liquid contains a colorant, the image density enhancing effect may be obtained. Moreover, by using a processing liquid containing a colorant as a color ink for an inkjet printer, the number of the printing heads to be installed in the printer may be reduced, so that the production cost of the recording apparatus and the running cost at the time of printing may be reduced.

The volume average particle diameter of the colorant may be 10 nm to 1,000 nm, particularly 30 nm to 250 nm, and more particularly 50 nm to 200 nm. In the case where the volume average particle diameter of the colorant is too small, the optical density may be low. On the other hand, in the case where the volume average particle diameter of the colorant is too large, the storage stability and the ejection stability may not be ensured.

A volume average particle diameter of a colorant denotes a particle diameter of the colorant itself, or a particle diameter of the colorant with an additive adhered thereto when the additive such as a dispersant is adhered to the colorant. In the invention, as the apparatus for measuring the volume average particle diameter, MICROTRUCK UPA particle size analyzer 9340 (produced by Leeds & Northrup Corp.) is used. The measurement is carried out with 4 ml of an inkjet ink placed in a measurement cell according to a predetermined measuring method. As the parameters to be inputted at the time of the measurement, the viscosity of the inkjet ink is inputted as the viscosity, and the density of the colorant is inputted as the density of the dispersion particles.

### (Pigment Dispersant)

Here, in the case where a pigment is used as the colorant, a pigment dispersant may be used in addition to the pigment. As a usable pigment dispersant, a polymer dispersant, an anionic surfactant, a cationic surfactant, an amphoteric surfactant, a nonionic surfactant, and the like may be exemplified. A nonionic surfactant may be use in terms of the dispersion stability of the pigment.

As the polymer dispersant, a polymer having a hydrophilic structure part and a hydrophobic structure part may be used. As the polymer having a hydrophilic structure part and a hydrophobic structure part, a condensation polymer and an addition polymer may be used. As the condensation polymer, known polyester dispersants may be exemplified. As the addition polymer, addition polymers of monomers having an α,β-ethylenically unsaturated group may be exemplified. By appropriately copolymerizing a monomer having an α,β-ethylenically unsaturated group and a hydrophilic group and a monomer having an α,β-ethylenically unsaturated group and a hydrophobic group in combination, a targeted polymer dispersant may be obtained. A homopolymer of a monomer having an α,β-ethylenically unsaturated group and a hydrophilic group may be used as well.

As the monomer having an α,β-ethylenically unsaturated group and a hydrophilic group, monomers having a carboxyl group, a sulfonic acid group, a hydroxyl group, a phosphoric acid group, or the like, such as acrylic acid, methacrylic acid, crotonic acid, itaconic acid, itaconic acid monoester, maleic acid, maleic acid monoester, fumaric acid, fumaric acid monoester, vinyl sulfonic acid, styrene sulfonic acid, sulfonated vinyl naphthalene, vinyl alcohol, acrylamide, methacryloxy ethyl phosphate, bismethacryloxy ethyl phosphate, methacryloxy ethyl phenyl acid phosphate, ethylene glycol dimethacrylate, and diethylene glycol dimethacrylate may be exemplified.

As the monomer having an α,β-ethylenically unsaturated group and a hydrophobic group, styrene derivatives such as styrene, α-methylstyrene and vinyl toluene, vinyl cyclohexane, vinyl naphthalene, vinyl naphthalene derivatives, alkyl acrylate, alkyl methacrylate, phenyl methacrylate, cycloalkyl methacrylate, alkyl crotonate, dialkyl itaconate, dialkyl maleate and the like are exemplified.

Specific examples of the polymer which is used as a polymer dispersant include styrene-styrene sulfonic acid copolymer, styrene-maleic acid copolymer, styrene-methacrylic acid copolymer, styrene-acrylic acid copolymer, vinylnaphthalene-maleic acid copolymer, vinylnaphthalene-methacrylic acid copolymer, vinylnaphthalene-acrylic acid copolymer, alkyl acrylate-acrylic acid copolymer, alkyl methacrylate-methacrylic acid copolymer, styrene-alkyl methacrylate-methacrylic acid copolymer, styrene-alkyl acrylate-acrylic acid copolymer, styrene-phenyl methacrylate-methacrylic acid copolymer, and styrene-cyclohexyl methacrylate-methacrylic acid copolymer. In addition, a monomer having a polyoxyethylene group or a hydroxyl group may be appropriately copolymerized in these copolymers.

The copolymer may have any structure, and may be a random, block, or graft copolymer. Polystyrene sulfonic acid, polyacrylic acid, polymethacrylic acid, polyvinylsulfonic acid, polyalginic acid, polyoxyethylene-polyoxypropylene-polyoxyethylene block copolymers, formalin condensates of naphthalene sulfonic acid, polyvinyl pyrrolidone, polyethyleneimine, polyamines, polyamides, polyvinylimidazoline, aminoalkylacrylate-acrylamide copolymers, chitosan, polyoxyethylene fatty acid amide, polyvinyl alcohol, polyacrylamide, cellulose derivatives such as carboxymethyl cellulose and carboxyethyl cellulose, polysaccharides and derivatives thereof, and the like may also be used.

Although not particularly limited, the hydrophilic group of a pigment dispersant may be an acidic group, and particularly a carboxylic acid or a salt of a carboxylic acid. A carboxyl group may form a crosslinking structure with a polyvalent metal ion, so that a pigment may have an appropriate aggregation structure.

Of these polymers, a polymer in which the hydrophilic group is an acidic group may be used in a salt form with a basic compound for the enhancement of water solubility. Examples of the compounds that form salts with the polymers include alkali metals such as sodium, potassium and lithium, aliphatic amines such as monomethylamine, dimethylamine and triethylamine, alcohol amines such as monomethanol amine, monoethanol amine, diethanol amine, triethanol amine and diisopropanol amine, ammonia, and the like. Basic compounds of alkali metals such as sodium, potassium and lithium may be used. A basic compound of an alkali metal is a strong electrolyte and thus has a large effect of promoting dissociation of an acidic group.

The amount of neutralization of a pigment dispersant may be 50% or more, particularly 80% or more, based on the acid value of the copolymer. The neutralization may be carried out, as appropriate, with sodium hydroxide or potassium hydroxide.

These pigment dispersants may be used alone or in combination of two or more kinds thereof. Although the addition amount of the pigment dispersant varies depending on the types of the pigments, it may be 0.1 to 100% by mass in total, particularly 1 to 70% by mass, and further particularly 3 to 50% by mass, based on the mass of the pigment.

From the viewpoint of obtaining both the dispersing property of the pigment and the ink ejection property, the polymer dispersant may have a weight average molecular weight of 2,000 to 50,000, particularly 3,000 to 30,000, and more particularly 4,000 to 20,000.

### (Water-Soluble Organic Solvent)

Next, water-soluble organic solvents will be mentioned. As water-soluble organic solvents, polyhydric alcohols, polyhydric alcohol derivatives, nitrogen-containing solvents, alcohols and sulfur-containing solvents may be used.

Specific examples of the polyhydric alcohols include ethylene glycol, diethylene glycol, propylene glycol, butylene glycol, triethylene glycol, 1,5-pentane diol, 1,2,6-hexane triol and glycerin.

Specific examples of the polyhydric alcohol derivative include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerin.

Specific examples of the nitrogen-containing solvent include pyrrolidone, N-methyl-2-pyrrolidone, cyclohexyl pyrrolidone, triethanol amine. Specific examples of the alcohols include ethanol, isopropyl alcohol, butyl alcohol, and benzyl alcohol. Specific examples of the sulfur-containing solvent include thiodiethanol, thiodiglycerol, sulfolane, and dimethyl sulfoxide.

In addition, it is also possible to use propylene carbonate and ethylene carbonate as a water-soluble organic solvent.

One or more kinds of water-soluble organic solvent may be used. The content of the water-soluble organic solvent may be 1% by mass to 60% by mass, and particularly 5% by mass to 40% by mass, based on the total mass of the ink. When the content of the water-soluble organic solvent in the ink is less than 1% by mass, a sufficient optical density may not be obtained. To the contrary, when the content of the water-soluble organic solvent is more than 60% by mass, the viscosity of the liquid is increased, so that the ejection characteristics of the liquid may become unstable.

Next, water will be explained. As the water, in order to prevent introduction of impurities, ion exchange water, ultra pure water, distilled water or ultrafiltrated water may be used.

### (Inkjet Processing Liquid)

Next, inkjet processing liquids will be described.

The inkjet processing liquid in the invention contains a compound having a function of aggregating, thickening or insolubilizing a component of an ink. Examples of the compound include inorganic electrolytes, acidic compounds (organic acids, inorganic acids), and organic amines. Of these, acidic compounds, particularly organic acids, may be used. Examples of the acidic compounds include benzoic acid, citric acid, glycolic acid, succinic acid, acetic acid, tartaric acid and 2-furancarboxylic acid.

The pKa of the acidic compound (acid dissociation constant, 25° C.) may be 6.0 or less. This is because an ink may aggregate at a pH of 6 or smaller.

### (Method of Determining the pKa of an Acidic Compound)

The pKa value at 25° C. is determined from an acid-base titration curve. That is, an acidic compound solution containing a known amount of an acidic compound and sodium hydroxide solution containing a known amount of sodium hydroxide are prepared, and the sodium hydroxide solution is added to the acidic compound solution. At this time, the addition amount of sodium hydroxide and the pH of the acidic compound solution are measured. The measured value obtained in this manner and the theoretical value obtained from a theoretical curve are optimized to obtain the acid dissociation constant. The details of the optimization method used are described in Journal of Chemical Software, Vol. 7, No. 4, pp. 191-196 (2001).

For example, the theoretical curve is represented by the following Formula (1) in the case of using a triacid.

$$\text{Formula} ( 1 ) \text{:}$$

$${V}_{B} = \{ \frac{\frac{{K}_{1}}{[ {H}^{+} ]} + 2 \frac{{K}_{1} {K}_{2}}{{[ {H}^{+} ]}^{2}} + 3 \frac{{K}_{1} {K}_{2} {K}_{3}}{{[ {H}^{+} ]}^{3}}}{1 + \frac{{K}_{1}}{[ {H}^{+} ]} + \frac{{K}_{1} {K}_{2}}{{[ {H}^{+} ]}^{2}} + \frac{{K}_{1} {K}_{2} {K}_{3}}{{[ {H}^{+} ]}^{3}}} {C}_{A} - ( [ {H}^{+} ] - [ O {H}^{-} ] ) \} \frac{{V}_{A}}{{C}_{B} + ( [ {H}^{+} ] - [ O {H}^{-} ] )}$$

In Formula (1), V_{A} represents the amount of an aqueous acid solution, V_{B} represents the amount of titration of an aqueous alkali solution, C_{A} represents the concentration of an aqueous acid solution, C_{B} represents the concentration of an aqueous alkali solution, K₁, K₂, and K₃ represent the acid dissociation constants of the first, second and third stages respectively, [H⁺] represents the hydrogen ion concentration in the aqueous solution, and [OH⁻] represents the hydroxide ion concentration in the aqueous solution.

In the invention, in a case of a compound having a plurality of acidic groups, the smallest value of the pKa values of the plurality of acidic groups is used.

The content of the acidic compound may be in the range of 0.01 mass % to 30 mass %, particularly in the range of 0.1 mass % to 15 mass %, and more particularly in the range of 0.25 mass % to 10 mass %, based on the mass of the processing liquid. When the content of the acidic compound in the processing liquid is less than 0.01 mass %, the aggregation of a colorant may be insufficient when contacting with an ink, so that the optical density, bleeding and intercolor bleeding may be worsened. When the content exceeds 30 mass %, the ejection characteristics may be lowered, whereby the processing liquid may not be ejected properly.

Next, water soluble organic solvents will be set forth. A water soluble organic solvent similar to that for the inkjet ink may be used for the processing liquid. The content of the water soluble organic solvent may be in the range of 1 mass % to 60 mass %, particularly in the range of 5 mass % to 40 mass %, based on the total mass of the processing liquid. When the amount of the water soluble organic solvent in the processing liquid is less than 1 mass %, a sufficient optical density may not be obtained; when the amount exceeds 60 mass %, the viscosity of the liquid is large, whereby the ejection characteristics of the liquid may become unstable.

Next, water will be described. Water may be added in an amount such that the surface tension and viscosity as described later are obtained. The addition amount of water is not particularly limited, and may be in the range of 10 mass % to 99 mass %, and particularly in the range of 30 mass % to 80 mass %, based on the total mass of the processing liquid.

Next, other additives in the processing liquid will be set forth.

A colorant may be contained in a processing liquid. As the colorant contained in the processing liquid, the above-described pigment for the inkjet ink, and other known pigments or dyes may be used.

When a pigment is used in a processing liquid, the volume average particle diameter of the pigment may be in the range of 30 nm to 250 nm, particularly in the range of 50 nm to 200 nm, more particularly in the range of 75 nm to 175 nm. When the volume average particle diameter of a pigment is less than 30 nm, the optical density may be lowered, whereas when the volume average particle diameter exceeds 250 nm, the storage stability and ejection stability may not be ensured.

Regarding the pH of the ink and the pH of the processing liquid, the pH of the ink may be larger than the pH of the processing liquid; and the difference between the pH of the ink and the pH of the processing liquid may be from 2 to 7.

Various additives may be added to the ink. For example, polyethylene imine, polyamines, polyvinyl pyrrolidone, polyethylene glycol, ethyl cellulose and carboxy methyl cellulose may be added in order to control the ink ejection characteristics; and alkali metal compounds such as potassium hydroxide, sodium hydroxide and lithium hydroxide may be added for adjusting the conductivity and the pH. As needed, a pH buffer, an antioxidant, a fungicide, a viscosity adjusting agent, a conductive agent, an ultraviolet ray absorbing agent, a chelating agent, or the like may be added as well.

Next, appropriate characteristics of the ink will be mentioned. First, the surface tension of the ink may be in the range of from 20 mN/m to 60 mN/m. The surface tension may be particularly in the range of from 20 mN/m to 50 mN/m, and more particularly in the range of from 25 mN/m to 33 mN/m. When the surface tension is less than 20 mN/m, the ink may overflow on a nozzle surface and thus printing may not be carried out normally. On the other hand, when the surface tension of the ink is higher than 60 mN/m, the penetrating speed may be lower, so that the drying time may be longer. The ink in the invention has a high penetrating property and thus the drying time thereof is short, whereby high speed printing is possible.

The surface tension of the processing liquid may be 20 to 60 mN/m, particularly 20 to 50 mN/m, and more particularly 25 to 33 mN/m.

The surface tension in the invention is measured under the conditions of 23° C. and 55% RH using a WILLHERMY type surface tension meter (produced by Kyowa Kaimen Kagaku Corp.).

The viscosity of the ink may be in the range of from 1.2 mPa·s to 30 mPa·s, particularly in the range of from 1.2 mPa·s to 20 mPa·s, and more particularly in the range of from 1.5 mPa·s to 15 mPa·s. When the viscosity of the ink is more than 30 mPa·s, the ejection characteristics may be deteriorated. When the viscosity of the ink is less than 1.2 mPa·s, the ejection characteristics may be deteriorated.

The viscosity of the processing liquid may be in the range of from 1.2 mPa·s to 25 mPa·s, particularly in the range of from 1.5 mPa·s to 10 mPa·s, and more particularly in the range of from 1.8 mPa·s to 5 mPa·s. When the viscosity of the processing liquid is more than 25 mPa·s, the ejection characteristics may be deteriorated. When the viscosity is less than 1.2 mPa·s, the long term storage stability may be deteriorated.

The viscosity is measured at a temperature of 23° C. and at a shearing speed of 1,400 s⁻¹, using REOMAT 115 (produced by Contraves) as a measurement device.

The pH of the ink and the pH of the processing liquid may be adjusted by adding sodium hydroxide or potassium hydroxide as needed.

### <Inkjet Ink Tank>

The inkjet ink set tank of the invention (including an inkjet ink tank and an processing liquid tank) houses the liquids (the inkjet ink and the processing liquid) of the inkjet ink set of the invention. For example, the ink tank disclosed in JP-A No. 2001-138541, or the like may be used. In this case, when the ink tank is filled with the ink and the ink is ejected from a recording head, the change in the ink characteristics over a long term storage in the ink tank may be suppressed, so that, in particular, the ink ejection characteristics from the recording head after the ink has been stored in the tank for a long period of time may be sufficiently satisfactory.

### <Inkjet Recording Apparatus>

The inkjet recording apparatus of the present invention includes: a recording head that ejects each liquid of the inkjet ink set of the present invention onto a recording medium; and a heater that heats the recording medium at least before or after ejecting each liquid of the ink set onto the recording medium.

Examples of the heater include a heater disposed above or below the area where a recording medium is transported in an inkjet recording apparatus, a heater that supplies hot air to the area where a recording medium is transported, and a heating roller; however, they are not particularly limited thereto.

In the inkjet recording apparatus of the present invention, with respect to the ink and the processing liquid, the liquid volume per one liquid drop may be from 1 pL to 200 pL, particularly 1 pL to 100 pL, and more particularly 1 pL to 80 pL. When the liquid volume per one liquid drop exceeds 200 pL, the resolution of an image may become deteriorated. It is considered that the deterioration of the image resolution is caused by a tendency of readily spreading of the liquid drop over the recording medium (paper) surface as the liquid volume per one liquid drop (drop amount) increases, due to the change in the contact angles of the ink and processing liquid on the surface of the recording medium depending on the liquid volume per one liquid drop. When the liquid mass per one liquid drop is less than 0.01 ng, the ejection stability may be deteriorated.

In an inkjet apparatus capable of ejecting a plurality of liquid drops from one nozzle, the drop amount indicates the drop amount of a minimum drop capable of carrying out printing.

A paper width head refers to a paper width head in which ink nozzles are arranged completely in one line as conventionally present, or a staggered arrangement head in which ink nozzles are disposed in a zigzag fashion in the main scanning direction and tightly arranged in the direction perpendicular to the sheet transporting direction.

In the inkjet recording apparatus of the present invention, the ink and the processing liquid may be replenished (supplied) to the recording head from the ink tanks (including a processing liquid tank) filled with the ink and processing liquid. The ink tanks may be cartridge type ink tanks which are detachably mounted to the apparatus, and the ink and the processing liquid may be readily supplied by replacing the cartridge type ink tanks.

Exemplary embodiments of the inkjet recording apparatus according to the invention will be described below in detail with reference to the drawings.

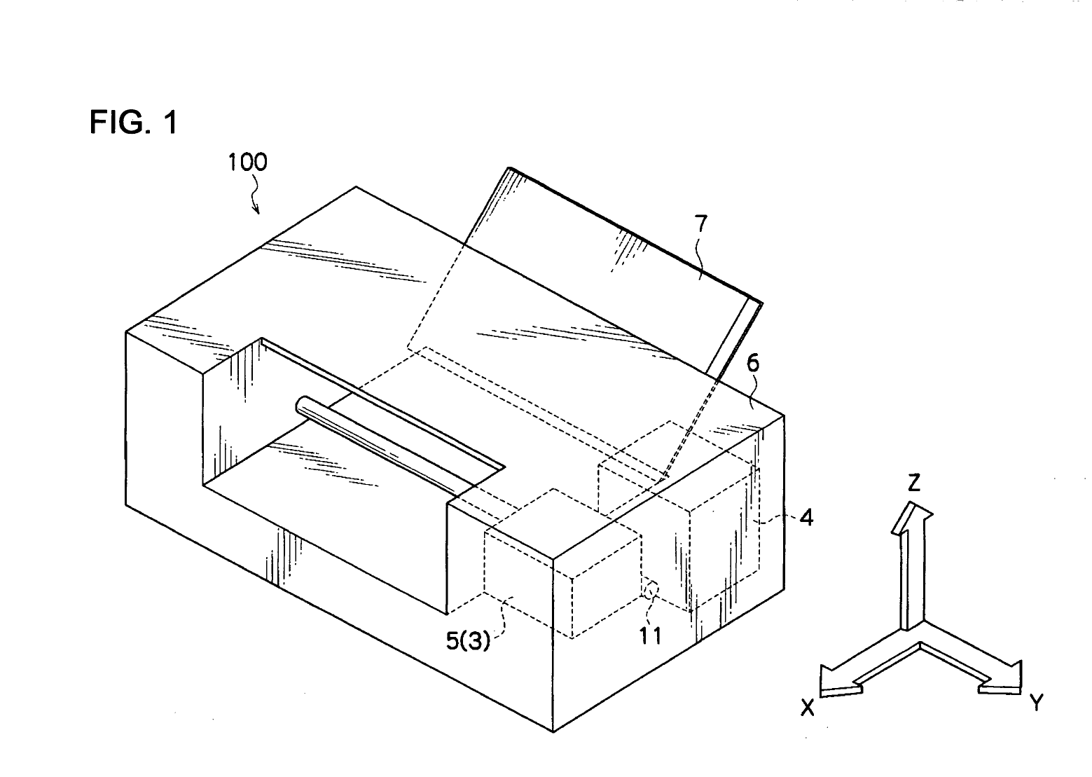

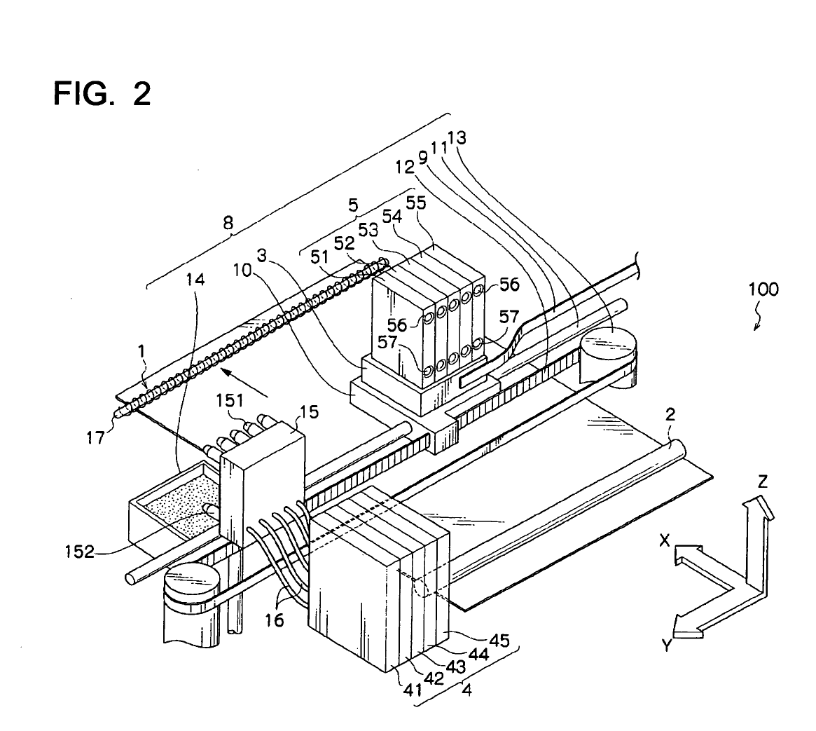

FIG. 1 is a perspective view showing the structure of an external appearance according to an exemplary embodiment of the inkjet recording apparatus of the present invention. FIG. 2 is a perspective view showing the basic structure of the interior of the inkjet recording apparatus (which will be hereinafter referred to as the image forming apparatus) in FIG. 1.

As shown in FIGS. 1 and 2, the image forming apparatus 100 includes an external cover 6, a tray 7 capable of loading a predetermined amount of a recording medium 1 such as a plain paper, a feed roller (transporting means) 2 that feeds the recording medium 1 for each sheet into the image forming apparatus 100, an image forming portion 8 (image forming means) that ejects an ink and a processing liquid to the surface of the recording medium 1 to thereby form an image, a main ink tank 4 which supplies the ink and the processing liquid to each sub-ink tank 5 in the image forming portion 8, and a heater 17.

The feed roller 2 is a paper feeding mechanism constituted by a pair of rollers provided rotatably in the image forming apparatus 100, and the pair of rollers hold therebetween the recording medium 1 loaded on the tray 7 and feed the recording medium 1 in a predetermined number into the image forming apparatus 100 for each sheet at a predetermined timing.

The image forming portion 8 forms an image with an ink on the surface of the recording medium 1. The image forming portion 8 includes a recording head 3, a sub-ink tank 5, a power supplying signal cable 9, a carriage 10, a guide rod 11, a timing belt 12, a driving pulley 13, and a maintenance unit 14.

The sub-ink tank 5 has sub-ink tanks 51, 52, 53, 54 and 55 which store inks and a processing liquid having different colors from each other so as to be ejected from the recording head. These tanks house a black ink (K), a yellow ink (Y), a magenta ink (M) and a cyan ink (C) as a first liquid and a processing liquid as a second liquid, which are supplied from the main ink tank 4, for example.

Each tank of sub-ink tank 5 has a vent hole 56 and a supplying hole 57. When the recording head 3 moves to a standby position (or a supplying position), a bent pin 151 and a supplying pin 152 of a supplying device 15 are inserted into the vent hole 56 and the supplying hole 57, respectively, so that the sub-ink tank 5 and the supplying device 15 may be connected to each other. The supplying device 15 is connected to the main tank 4 through a supplying tube 16, and the ink or the processing liquid is supplied from the main ink tank 4 to the sub-ink tank 5 through the supplying hole 57.

The main ink tank 4 includes main ink tanks 41, 42, 43, 44 and 45 which include inks having different colors and a processing liquid, which ink tanks may be filled with the black ink (K), the yellow ink (Y), the magenta ink (M) and the cyan ink (C) as the first liquid, and the processing liquid as the second liquid, and are detachably housed in the image forming apparatus 100.

Furthermore, a power supplying signal cable 9 and the sub-ink tank 5 are connected to the recording head 3. When external image recording information is inputted from the power supplying signal cable 9 to the recording head 3, the recording head 3 sucks an ink in a predetermined amount from each of the ink tanks and ejects the ink onto the surface of the recording medium based on the image recording information. The power supplying signal cable 9 also supplies an electric power to the recording head 3 for driving the recording head 3, in addition to the image recording information.

Moreover, the recording head 3 is provided and held on the carriage 10, and the guide rod 11 and the timing belt 12 connected to the driving pulleys 13 are connected to the carriage 10. By such a structure, the recording head 3 may be moved in a direction Y (a main scanning direction) which is parallel with the surface of the recording medium 1 and is perpendicular to a transporting direction X (a sub-scanning direction) of the recording medium 1 along the guide rod 11.

The image forming apparatus 100 includes a control means (not shown) that controls the driving timing of the recording head 3 and the driving timing of a carriage 10 in accordance with the image recording information. Accordingly, it is possible to continuously form an image in accordance with the image recording information in a predetermined region on the surface of the recording medium 1 which is transported at a predetermined speed in the transporting direction X.

The maintenance unit 14 is connected to a pressure reducing device (not shown) through a tube. Furthermore, the maintenance unit 14 is connected to the nozzle portion of the recording head 3 and functions to reduce the pressure in the interior of the nozzle of the recording head 3, thereby sucking an ink from the nozzle of the recording head 3. By providing the maintenance unit 14, it is possible to remove an excessive ink in the nozzle, which ink is adhered during the operation of the image forming apparatus 100, if necessary, or to suppress the evaporation of the ink from the nozzle in a non-operated state.

The heater 17 is disposed at the downstream side in the transporting direction X (sub scanning direction) of the recording medium 1. The heater may be disposed so as to heat a recording medium at least before or after ejecting each liquid onto the recording medium, i.e., the heater 17 may be placed at both the upstream and downstream sides in the transporting direction X, or placed only at the upstream side, and is not limited thereto.

The heater in the drawings is disposed so as to heat from above the recording medium 1; however, it may be disposed so as to heat from below the recording medium 1.

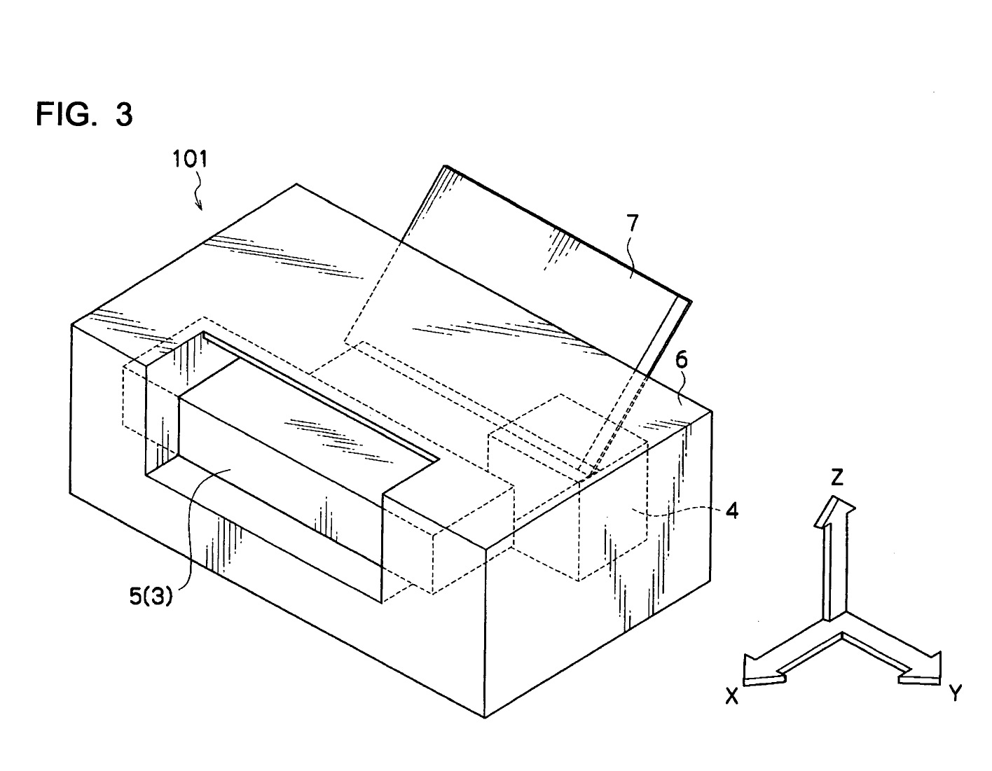

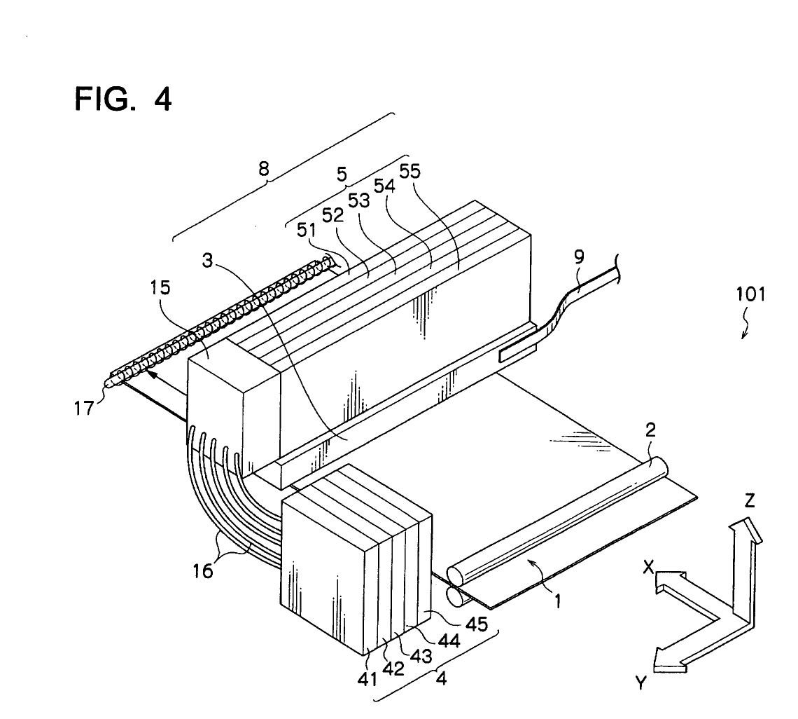

FIG. 3 is a perspective view showing the structure of an appearance of an exemplary embodiment of the inkjet recording apparatus according to the invention. FIG. 4 is a perspective view showing the basic structure of the interior of the inkjet recording apparatus (which will be hereinafter referred to as the image forming apparatus) in FIG. 3.

As shown in FIGS. 3 and 4, the image forming apparatus 101 includes an external cover 6, a tray 7 capable of loading a predetermined amount of a recording medium 1 such as a plain paper, a feed roller (transporting means) 2 that feeds the recording medium 1 for each sheet into the image forming apparatus 101, an image forming portion 8 (image forming means) that ejects an ink and a processing liquid to the surface of the recording medium 1 to thereby form an image, a main ink tank 4 which supplies the ink and the processing liquid to each sub-ink tank 5 in the image forming portion 8, and a heater 17.

The image forming apparatus 101 shown in FIGS. 3 and 4 includes a recording head 3 having a width which is equal to or greater than the width of a recording medium 1, does not include a carriage mechanism, and has a paper feeding mechanism (which is feeding rollers 2 in the exemplary embodiment, but may be a paper feeding mechanism of a belt type, for example) in a sub-scanning direction (the transporting direction of the recording medium 1: the direction of the arrow X).

Although not shown, sub-ink tanks 51 to 55 are arranged sequentially in the sub-scanning direction (the transporting direction of the recording medium 1: the direction of the arrow X), and similarly a group of nozzles that eject each color (including a processing liquid) are arranged in the sub-scanning direction. Since other structures are the same as those of the image forming apparatus 100 shown in FIGS. 1 and 2, description thereof will be omitted. In the drawing, the recording head 3 is not movable and, accordingly, the sub ink tank 5 is always connected to a supplying device 15. However, the sub ink tank 5 may be connected to the supplying device 15 only when the ink is supplied thereto.

The image forming apparatus 101 shown in FIGS. 3 and 4 collectively carries out printing in the width direction (main scanning direction) of the recording medium 1 by means of the recording head 3. Therefore, the structure of the apparatus may be more simplified and the printing speed is more increased than a type having a carriage mechanism.

### <Recording Method>

The recording method of the present invention is an inkjet recording method including: ejecting each liquid of the inkjet ink set of the present invention onto a recording medium; and heating the recording medium at least before or after ejecting each liquid of the ink set onto the recording medium.

In the recording method of the invention, the inkjet recording apparatus of the present invention may be used.

### EXAMPLES

The invention is more specifically set forth in terms of examples hereinafter; however, the invention is by no means limited to these examples.

### <Method of Preparing an Ink>

A colorant solution, a water-soluble organic solvent, a surfactant, an acidic compound, a saccharide and a derivative thereof, ion exchanged water, etc. are put together in appropriate amounts so as to obtain a predetermined composition, and the mixture solution is admixed and agitated. The resulting solution is passed through a 5 μm filter and the desired solution is obtained.

### (Ink 1) Bk Ink

Black Pearls L: 5 mass %

Styrene-methacrylic acid-potassium methacrylate copolymer: 1.5 mass %
Diethylene glycol: 5 mass %
Acetylene glycol ethylene oxide adduct: 1.5 mass %

### D-sorbitol C₆(H₂O)₆H₂: 20 mass %

### Glycerin C₃(H₂O)₃H₂: 10 mass %

Ion exchanged water: balance

In this solution, the pH is 9.0, the surface tension is 32 mN/m, the viscosity is 4.8 mPa·s, and the volume average particle diameter is 90 nm.

### (Ink 2) Cyan Ink

### C.I. Pigment Blue 15:3: 4 mass %

Styrene-methacrylic acid-potassium methacrylate copolymer: 1.5 mass %
Triethylene glycol monobutyl ether: 6 mass %
Acetylene glycol ethylene oxide adduct: 1.5 mass %

### Xylitol C₅(H₂O)₅H₂: 30 mass %

### Glycerin C₃(H₂O)₃H₂: 5 mass %

Ion exchanged water: balance

In this solution, the pH is 9.2, the surface tension is 33 mN/m, the viscosity is 5.4 mPa·s, and the volume average particle diameter is 75 nm.

### (Ink 3) Magenta Ink

### C.I. Pigment Red 122: 6 mass %

Styrene-methacrylic acid-potassium methacrylate copolymer: 2 mass %
Triethylene glycol monobutyl ether: 6 mass %
Acetylene glycol ethylene oxide adduct: 1.5 mass %

### D-glucose C₆(H₂O)₆: 20 mass %

### Glycerin C₃(H₂O)₃H₂: 10 mass %

Ion exchanged water: balance

In this solution, the pH is 8.8, the surface tension is 32 mN/m, the viscosity is 5.3 mPa·s, and the volume average particle diameter is 121 nm.

### (Ink 4) Bk Ink

### Cabojet 300: 5 mass %

Styrene-methacrylic acid-potassium methacrylate copolymer: 2.5 mass %
Triethylene glycol monobutyl ether: 8 mass %
Acetylene glycol ethylene oxide adduct: 1 mass %

### D-xylose C₅(H₂O)₅: 25 mass %

### Glycerin C₃(H₂O)₃H₂: 5 mass %

Ion exchanged water: balance

In this solution, the pH is 8.8, the surface tension is 31 mN/m, the viscosity is 4.8 mPa·s, and the volume average particle diameter is 121 nm.

### (Ink 5) Bk Ink

### Cabojet 300: 5 mass %

Acetylene glycol ethylene oxide adduct: 0.5 mass %
Diethylene glycol: 20 mass %
Ion exchanged water: balance

In this solution, the pH is 8.6, the surface tension is 39 mN/m, the viscosity is 2.8 mPa·s, and the volume average particle diameter is 121 nm.

### (Ink 6) Bk Ink

### Cabojet 300: 4 mass %

Styrene-methacrylic acid-potassium methacrylate copolymer: 1.5 mass %
Diethylene glycol: 30 mass %
Acetylene glycol ethylene oxide adduct: 1 mass %
Ion exchanged water: balance

In this solution, the pH is 8.8, the surface tension is 33 mN/m, the viscosity is 4.0 mPa·s, and the volume average particle diameter is 82 nm.

### (Ink 7) Bk Ink

### Black Pearls L: 5 mass %

Styrene-methacrylic acid-potassium methacrylate copolymer: 1.5 mass %
Diethylene glycol: 5 mass %

### Ethylene glycol C₂(H₂O)₂H₂: 30 mass %

Ion exchanged water: balance

In this solution, the pH is 9.0, the surface tension is 32 mN/m, the viscosity is 3.9 mPa·s, and the volume average particle diameter is 90 nm.

### (Processing liquid 1)

### Glycerin C₃(H₂O)₃H₂: 10 mass %

Acetylene glycol ethylene oxide adduct: 1.5 mass %

### Xylitol C₅(H₂O)₅H₂: 20 mass %

### Citric acid pKa=2.90 (25° C.): 8 mass %

Ion exchanged water: balance

Furthermore, the pH is adjusted with sodium hydroxide.

In this solution, the pH is 3.4, the surface tension is 29 mN/m, and the viscosity is 3.4 mPa·s.

### (Processing liquid 2)

Diethylene glycol: 10 mass %

### 1,2-Hexanediol: 4 mass %

Acetylene glycol ethylene oxide adduct: 1 mass %

### Glycerin C₃(H₂O)₃H₂: 20 mass %

d-Tartaric acid pKa=2.82 (25° C.): 8 mass %
Ion exchanged water: balance

Furthermore, the pH is adjusted with sodium hydroxide.

In this solution, the pH is 3.7, the surface tension is 30 mN/m, and the viscosity is 3.7 mPa·s.

### (Processing liquid 3)

Diethylene glycol: 30 mass %
Triethylene glycol monobutyl ether: 4 mass %
Acetylene glycol ethylene oxide adduct: 1 mass %

### Citric acid pKa=2.90 (25° C.): 8 mass %

Ion exchanged water: balance

Furthermore, the pH is adjusted with sodium hydroxide.

In this solution, the pH is 3.4, the surface tension is 30 mN/m, and the viscosity is 3.4 mPa·s.

### (Processing liquid 4) The case of m=2

### Ethylene glycol C₂(H₂O)₂H₂: 30 mass %

Triethylene glycol monobutyl ether: 4 mass %
Acetylene glycol ethylene oxide adduct: 1.5 mass %

### Citric acid pKa=2.90 (25° C.): 8 mass %

Ion exchanged water: balance

Furthermore, the pH is adjusted with sodium hydroxide.

In this solution, the pH is 3.3, the surface tension is 29 mN/m, and the viscosity is 3.3 mPa·s.

### (Processing liquid 5) The case of m=6

### D-glucose C₆(H₂O)₆: 30 mass %

Triethylene glycol monobutyl ether: 4 mass %
Acetylene glycol ethylene oxide adduct: 1.5 mass %

### Citric acid pKa=2.90 (25° C.): 8 mass %

Ion exchanged water: balance

Furthermore, the pH is adjusted with sodium hydroxide.

In this solution, the pH is 3.5, the surface tension is 29 mN/m, and the viscosity is 4.8 mPa·s.

### Examples 1 to 6, and Comparative Examples 1 to 4

In combinations of inks/processing liquids as shown in Table 1, printing is carried out using an experimental printer having a plurality of experimental print heads of 600 dpi and 4960 units per color and having a maintenance unit singly housing a plurality of inks (a heater is disposed at a downstream side from the recording head in the recording medium transporting direction; see FIG. 4), and the following evaluations are performed. In a combination of each liquid of the examples and comparative examples, the ink and processing liquid are printed on FX-P paper (manufactured by Fuji Xerox Co., Ltd.) in this order and then heated with the heater. The ejection amount of the ink is set to be 8 pl, and the ejection amount of the processing liquid is set to be 4 pl. Unless otherwise indicated below, printing is carried out under normal conditions (temperature of 23±0.5° C., humidity of 55±5% R.H.). The evaluations are carried out on samples that have been left to stand under the normal conditions for 24 hours after printing.

The results obtained are shown in Table 2. The compositions of each ink and processing liquid are summarized in Table 3.

### [Evaluations]

### (Optical Density)

A 100% coverage pattern is printed and the optical density is determined by means of X-RITE 404 (manufactured by X-Rite, Inc.). The evaluation criteria are in the following.

### For Black Inks

### A: the optical density is 1.5 or more.

### B: the optical density is 1.4 or more but less than 1.5.

### C: the optical density is 1.3 or more but less than 1.4.

### D: the optical density is less than 1.3.

### For Color Inks

### A: the optical density is 1.2 or more.

### B: the optical density is 1.1 or more but less than 1.2.

### C: the optical density is 1.0 or more but less than 1.1.

### D: the optical density is less than 1.0.

### (Bleeding)

A fine-line pattern is printed, and the degree of the bleeding of printed portions is visually evaluated by the comparison with boundary samples. The evaluation criteria are in the following.

### A: Substantially no bleeding is observed

### B: Bleeding is slightly observed.

### C: Bleeding is observed but acceptable.

### D: Bleeding is significantly observed and not acceptable.

### (Curling)

A 100% coverage pattern is printed in a range of A4 full solid (20×25 cm), and then the following evaluations are carried out.

### (Initial Curling Amount)

A printed sheet is allowed to stand at normal temperature and normal humidity for five hours, and then the curling amount is measured.

The printed sheet is put on a horizontal surface, and the height from the point at which the paper sheet is contacted with the horizontal surface to the edge of the curled paper sheet is measured with a ruler.

The evaluation criteria are as follows:

### A: less than 15 mm

### B: 15 mm or more

### (Curling Amount After Two Days)

A printed sheet is allowed to stand at normal temperature and normal humidity for two days, and then the curling amount is measured by the same method as above.

The evaluation criteria are as follows:

### A: less than 15 mm

### B: 15 mm or more but less than 30 mm

### C: 30 mm or more but less than 45 mm

### D: 45 mm or more

### (Stains on a Sheet After Continuous Printing)

A transporting roller is disposed at a downstream side from the heater in the recording medium transporting direction in the above-mentioned experimental printer (in which the heater is disposed at a downstream side from the recording head in the recording medium transporting direction; see FIG. 4). A 100% coverage pattern are continuously printed on 100 sheets for 1 minute, and then 1 sheet is transported without printing for evaluating stains transferred from the transporting roller. The optical density of the 101st sheet is measured to evaluate the stains.

### A: The optical density is 0.03 or less.

### B: The optical density is 0.04 or more but less than 0.07.

### C: The optical density is 0.08 or more.

TABLE 1

| | | | Presence or absence | |
|---|---|---|---|---|
| | | | of heating by a heater | ΔpH |
| Example 1 | Ink 1 | Processing liquid 1 | Present | 5.6 |
| Example 2 | Ink 2 | Processing liquid 1 | Present | 5.8 |
| Example 3 | Ink 3 | Processing liquid 2 | Present | 5.1 |
| Example 4 | Ink 4 | Processing liquid 2 | Present | 5.1 |
| Example 5 | Ink 1 | Processing liquid 3 | Present | 5.6 |
| Example 6 | Ink 3 | Processing liquid 5 | Present | 5.3 |
| Comparative | Ink 5 | Processing liquid 3 | Present | 5.2 |
| Example 1 | | | | |
| Comparative | Ink 6 | Processing liquid 3 | Present | 5.4 |
| Example 2 | | | | |
| Comparative | Ink 7 | Processing liquid 4 | Present | 5.7 |
| Example 3 | | | | |
| Comparative | Ink 3 | Processing liquid 5 | Absent | 5.3 |
| Example 4 | | | | |

ΔpH = ink pH − processing liquid pH

TABLE 2

| | | | | | Stains on |
|---|---|---|---|---|---|
| | | | Curling | | sheets after |
| | Optical | | | After | continuous |
| | density | Bleeding | Initial stage | 2 days | printing |
| Example 1 | A | A | A | A | A |
| Example 2 | A | A | A | A | A |
| Example 3 | B | B | A | B | A |
| Example 4 | B | A | A | A | A |
| Example 5 | A | A | A | B | A |
| Example 6 | B | B | A | A | A |
| Comparative | C | D | B | D | C |
| Example 1 | | | | | |
| Comparative | A | A | B | D | A |
| Example 2 | | | | | |
| Comparative | B | B | B | D | A |
| Example 3 | | | | | |
| Comparative | B | B | B | B | C |
| Example 4 | | | | | |

TABLE 3

| Ink Composition (wt %) | | Ink 1 | Ink 2 | Ink 3 | Ink 4 | Ink 5 | Ink 6 | Ink 7 |
|---|---|---|---|---|---|---|---|---|
| Coloring | Cabojet-300 | — | — | — | 5 | 5 | 4 | — |
| material | Black Pearls L | 5 | — | — | — | — | — | 5 |
| | C.I. Pigment Blue 15:3 | — | 4 | — | — | — | — | — |
| | C.I. Pigment Red 122 | — | — | 6 | — | — | — | — |
| Polymer | Styrene-methacrylic acid-potassium | 1.5 | 1.5 | 2 | 2.5 | — | 1.5 | 1.5 |
| | methacrylate copolymer | | | | | | | |
| Solvent | Diethylene glycol | 5 | — | — | — | 20 | 30 | 5 |
| | Triethylene glycol monobutyl ether | — | 6 | 6 | 8 | — | — | — |
| | 1,2-Hexanediol | — | — | — | — | — | — | — |
| Surfactant | Acetylene glycol ethylene oxide adduct | 1.5 | 1.5 | 1.5 | 1 | 0.5 | 1 | — |
| Cₘ(H₂O)ₙ or | D-xylose C₅(H₂O)₅ | — | — | — | 25 | — | — | — |
| Cₘ(H₂O)ₙH₂ | Xylitol C₅(H₂O)₅H₂ | — | 30 | — | — | — | — | — |
| | Glycerin C₃(H₂O)₃H₂ | 10 | 5 | 10 | 5 | — | — | — |
| | D-sorbitol C₆(H₂O)₆H₂ | 20 | — | — | — | — | — | — |
| | D-glucose C₆(H₂O)₆ | — | — | 20 | — | — | — | — |
| | Ethylene glycol C₂(H₂O)₂H₂ | — | — | — | — | — | — | 30 |
| Acidic | Citric acid pKa = 2.90, at 25° C. | — | — | — | — | — | — | — |
| Compound | d-Tartaric acid pKa = 2.82, at 25° C. | — | — | — | — | — | — | — |

| | | | | | | | |
|---|---|---|---|---|---|---|---|
| Water | Balance | Balance | Balance | Balance | Balance | Balance | Balance |
| pH | 9.0 | 9.2 | 8.8 | 8.8 | 8.6 | 8.8 | 9.0 |

| | | Processing | Processing | Processing | Processing | Processing |
|---|---|---|---|---|---|---|
| Ink Composition (wt %) | | liquid 1 | liquid 2 | liquid 3 | liquid 4 | liquid 5 |
| Coloring | Cabojet-300 | — | — | — | — | — |
| material | Black Pearls L | — | — | — | — | — |
| | C.I. Pigment Blue 15:3 | — | — | — | — | — |
| | C.I. Pigment Red 122 | — | — | — | — | — |
| Polymer | Styrene-methacrylic acid-potassium | — | — | — | — | — |
| | methacrylate copolymer | | | | | |
| Solvent | Diethylene glycol | — | 10 | 30 | — | — |
| | Triethylene glycol monobutyl ether | — | — | 4 | 4 | 4 |
| | 1,2-Hexanediol | — | 4 | — | — | — |
| Surfactant | Acetylene glycol ethylene oxide adduct | 1.5 | 1 | 1 | 1.5 | 1.5 |
| Cₘ(H₂O)ₙ or | D-xylose C₅(H₂O)₅ | — | — | — | — | — |
| Cₘ(H₂O)ₙH₂ | Xylitol C₅(H₂O)₅H₂ | 20 | — | — | — | — |
| | Glycerin C₃(H₂O)₃H₂ | 10 | 20 | — | — | — |
| | D-sorbitol C₆(H₂O)₆H₂ | — | — | — | — | — |
| | D-glucose C₆(H₂O)₆ | — | — | — | — | 30 |
| | Ethylene glycol C₂(H₂O)₂H₂ | — | — | — | 30 | — |
| Acidic | Citric acid pKa = 2.90, at 25° C. | 8 | — | 8 | 8 | 8 |
| Compound | d-Tartaric acid pKa = 2.82, at 25° C. | — | 8 | — | — | — |

| | | | | | |
|---|---|---|---|---|---|
| Water | Balance | Balance | Balance | Balance | Balance |
| pH | 3.4 | 3.7 | 3.4 | 3.3 | 3.5 |

The results in Table 2 show that, in each of the examples, curling is suppressed, bleeding is decreased, the optical density is high, a high quality image is obtained, and the examples are suitable for high-speed printing.

What is claimed is:

1. An inkjet ink set for use in an inkjet recording apparatus comprising a heater that heats a recording medium at least before or after ejecting each liquid of the ink set onto the recording medium, the ink set comprising:
an inkjet ink; and
an inkjet processing liquid comprising at least a compound having a function of aggregating, thickening or insolubilizing a component of the ink,
at least one of the ink or the processing liquid comprising at least one selected from the group consisting of saccharides represented by the following Formula (I) and derivatives thereof:
Cₘ(H₂O)ₙ Formula (I)
in Formula (I), m representing an integer of 3 to 6, and n representing an integer of 3 to 6, and
at least one of the ink or the processing liquid comprising a penetrating agent.

2. The inkjet ink set of claim 1, wherein the content of the saccharides and the derivatives thereof is from about 5 to about 40 mass % based on the total amount of the ink or the processing liquid.

3. The inkjet ink set of claim 1, wherein the penetrating agent comprises at least one selected from the group consisting of surfactants and penetrating organic solvents.

4. The inkjet ink set of claim 1, wherein the pH of the ink and the pH of the processing liquid satisfy the following formulae:
pH of the processing liquid<pH of the ink; and
pH of the ink−pH of the processing liquid=2 to 7.

5. The inkjet ink set of claim 1, wherein the processing liquid comprises an acidic compound having a pKa of about 6.0 or less (25° C.).

6. The inkjet ink set of claim 5, wherein the acidic compound is selected from the group consisting of benzoic acid, citric acid, glycolic acid, succinic acid, acetic acid, tartaric acid, and 2-furancarboxylic acid.

7. The inkjet ink set of claim 1, wherein the ink comprises a colorant and the colorant comprises a pigment.

8. The inkjet ink set of claim 1, wherein the ink and the processing liquid each have a surface tension of from about 25 to about 33 mN/m.

9. An inkjet ink tank housing the inkjet ink set of claim 1.

10. An inkjet recording apparatus comprising: a recording head that ejects each liquid of the inkjet ink set of claim 1 onto a recording medium; and a heater that heats the recording medium at least before or after ejecting each liquid of the ink set onto the recording medium.

11. The inkjet recording apparatus of claim 10, further comprising an inkjet ink tank that houses the inkjet ink set and supplies each liquid of the ink set to the recording head.

12. The inkjet recording apparatus of claim 10, wherein the width of the recording head is equal to or greater than the width of the recording medium.

13. An inkjet recording method comprising: ejecting each liquid of the inkjet ink set of claim 1 onto a recording medium; and
heating the recording medium at least before or after ejecting each liquid of the ink set onto the recording medium.

14. The inkjet recording method of claim 13, wherein the content of the saccharides and the derivatives thereof is from about 5 to about 40 mass % based on the total amount of the ink or the processing liquid.

15. The inkjet recording method of claim 13, wherein the penetrating agent comprises at least one selected from the group consisting of surfactants and penetrating organic solvents.

16. The inkjet recording method of claim 13, wherein the pH of the ink and the pH of the processing liquid satisfy the following formulae:
pH of the processing liquid<pH of the ink; and
pH of the ink−pH of the processing liquid=2 to 7.

17. The inkjet recording method of claim 13, wherein the processing liquid comprises an acidic compound having a pKa of about 6.0 or less (25° C.).

18. The inkjet recording method of claim 17, wherein the acidic compound is selected from the group consisting of benzoic acid, citric acid, glycolic acid, succinic acid, acetic acid, tartaric acid, and 2-furancarboxylic acid.

19. The inkjet recording method of claim 13, wherein the ink comprises a colorant and the colorant comprises a pigment.

20. The inkjet recording method of claim 13, wherein the ink and the processing liquid each have a surface tension of from about 25 to about 33 mN/m.
